(19) United States
(12) Patent Application Publication
(10) Pub. No.: US 2009/0144749 A1
(43) Pub. Date: Jun. 4, 2009

(54) Alert and Repair System for Data Scraping Routines

(75) Inventors: Andrew S. Van Luchene, Santa Fe, NM (US); Joel Mahoney, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, Santa Fe, NM (US)

(21) Appl. No.: 11/948,050

(22) Filed: Nov. 30, 2007

(51) Int. Cl. G06F 3/00

(52) U.S. Cl. 719/313

(57) ABSTRACT

A system and method of detecting and reporting the failure of a data scrape or redirect routine. In the event of a failure, the system may reattempt a data scrape based on different parameters. Such a system and method may further provide for the repair or replacement of failed routines with new or pre-existing routines.

### BACKGROUND

Data scraping is a technique in which a computer program extracts data from the display output of another program. Data scraping may be used to collect unstructured data from one or more web sites on the Internet and provide structured data. Collection of such data may be automated so that one or more target data sources can be monitored. When no data is returned from such a scrape, it may be difficult to determine if the absence of data is due to no data matching the criteria of the data scrape or because of a failure in the data scraping routine. It would therefore be advantageous to provide improved methods and apparatus for notification and repair of failures in a data scraping routine.

### BRIEF DESCRIPTION OF THE DRAWINGS

FIG. 1 is a block diagram depicting a network according to an embodiment of the present disclosure.

FIG. 2 is a block diagram depicting a system 100 according to one embodiment of the present invention.

FIG. 3 illustrates a method of monitoring scrapes and issuing an alert according to an embodiment of the invention.

FIG. 4 illustrates a method of monitoring and replacing scrape routines according to an embodiment of the invention.

FIG. 5 illustrates a method of compensating for a failed scrape or redirect according to an embodiment of the invention.

FIG. 6 illustrates a method of associating replacement routines according to an embodiment of the invention.

FIG. 7 illustrates a method of repairing redirect routines according to an embodiment of the invention.

### DETAILED DESCRIPTION

Data scraping routines provide a means for gathering and transforming information from websites. Collected data may be reformatted and imported into a database, spreadsheet, or other program, or displayed on another website on its own or as part of an interactive widget. Routines to collect data may be automated and their output checked periodically. In some instances, a data scrape may not return any data. It would be useful to know if the lack of data is due to a lack of information or a failure in the scraping routine so that the routine may be repaired or reattempted as quickly as possible. This is particularly important in instances where the information gathered is part of an informational or other service, an advertisement, or some other program or system that relies on or is otherwise influenced by the data that is scraped.

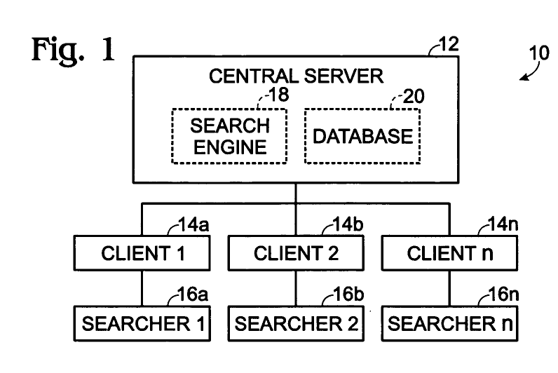

The herein described aspects and drawings illustrate components contained within, or connected with other components that permit improved monitoring and maintenance of data scraping routines and associated linkages. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Turning now to FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 20 may be located, collectively, or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, CD-RW, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In some embodiments, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

Data scraping allows for the extraction of data from the display output of another program. Data scraping may be used to emulate an interaction with a web site including extracting information, filling out forms, navigating the site and dealing with the HTML received. Data scraping can be used to enhance a Web service into doing something the designers have not themselves included. In some embodiments, the results of a data scrape may be displayed on a webpage or in a widget on a webpage. In other embodiments, additional linkages may be provided connecting the displayed results with the source of the data. However, reliance on data scraping can be problematic if the scrape routine does not generate a data set, for example if the source website changes. It may be difficult to determine if the lack of a data set is because there was no data that matched the parameters of the data scrape, or because of a failure in the routine.

It will be appreciated that scraping media need not be limited to only HTML. Other suitable media include, but are not limited to, XML, javascript, CSS, Adobe Flash pages, images, audio, etc.

Various embodiments of the invention address this issue by providing a system configured to verify if a data scrape as well as associated linkages were successful. Such verification may include an alert notification if the data scrape or other connection was unsuccessful as well as corrective actions to repair the failure. For example, a system may scrape posted data from inventory provider websites on a periodic basis using a set of pre-established scraping routines that interface with the inventory databases of the provider websites. Each time a data scraping routine is run, the system may determine if the data scraping routine was successful. If the routine was not successful, the system may flag the record.

An unsuccessful scrape may be identified whenever a certain set of criteria is met (or not met) for example, the system may identify a scrape as having been unsuccessful when a target HTML page (or website) is no longer available; when unexpected results are returned on a page (e.g. a hotel that is known to have only 100 rooms returns a result of having 1000 rooms available); when an error message is displayed on the webpage; when the results fall outside of a predetermined range (which may or may not be calculated by an algorithmic review of previous results); when the internal “CSS selectors” have been modified in such a way that the pertinent information can no longer be targeted (for example the target may be a div tag with a specific id and a certain color font or font treatment within the div.) Furthermore, keywords may be used to identify certain types of failures. For example, the phrases “page not found,” “error,” “no availability,” “the search dates you entered to not match any results,” etc., may be indicative of a particular type of failure and may be useful in determining the apprepiate repair procedure and/or alert to invoke.

In some embodiments, an alert may be issued indicating the failure of the routine. In other embodiments, end users may be connected with the source of the data through a redirect routine. In some embodiments, a failure to redirect the end user through a link between the display webpage and the source of the data may result in an alert being issued.

An alert may be any form of communication between the system initiating or monitoring the data scraping or other linkages and a third party such as an administrator, database, software application, legal agency, governing body, software interface, or any combination thereof. Alerts may be sent by any medium desired including but not limited to email messages, phone communications, instant messaging, text messaging, physical mail, voice mail, pager, graphic, text or audio message, record entry, or any combination thereof. In other embodiments, the system running the data scrape may attempt to repair or replace the failed data scraping routine or redirect routine. For example, the system may attempt alternate scraping or redirect routines. If an alternate scraping or redirect routine is found that is successful, the system may replace the previous data scraping or redirect routine with the new data scraping or redirect routine. In one embodiment, if the system is unable to locate an alternate data scraping or redirect routine that is successful, the system may create an alternate data scraping or redirect routine using a rules or genetic algorithm and replace the failed data scraping or redirect routine with the newly created routine. If a replacement routine is located, the replacement routine may be associated with the related data scrape or redirect routine. For example, if a data scrape routine fails, the redirect routine may be paired with the replacement data scrape routine and vice versa. In some embodiments, if the data scraping system is unable to obtain a data scrape, it may redirect the end user to the home page or other specified page of an inventory provider website until an alternate scrape or redirect routine has been implemented.

Alerts may be issued at any point after a routine has failed to return results. In some embodiments, an alert may be issued immediately. In another embodiment, an alert may be issued if the system fails to find or create a replacement routine. In a further embodiment, a routine may be run additional times up to a predetermined amount to verify that the routine was unsuccessful prior to issuing an alert. In yet another embodiment, the data scraping routine may modify its parameters to generate a successful scrape. For example, if a data scrape is performed based on particular search criteria such as a particular day or days, the data scrape may be expanded to a different day, or the next day or more or fewer days in order to obtain data. If the search criteria were for specific types of inventory, more general types of inventory may be searched. For example, if the search was for an item of a particular color, a search may be run for the item regardless of color. If no data is returned regardless of the arrangement of the parameters, an alert may be issued.

Data scraping may be used to emulate an interaction with a web site including extracting information, filling out forms, navigating the site and dealing with the HTML received. In some embodiments, information entered on a display website which outputs the information from the data scrape may be transferred to the website that is the source of the data scrape. For example, data scraping may be used to acquire inventory data from a provider website. In some embodiments, such information may be displayed in a widget. A widget is a piece of code that provides information on, or an interface to, a set of functionality or data. In order to obtain the inventory of interest, it may be necessary to enter certain data on the display website, for example, a description of the inventory of interest, prices, dates, locations, number of people involved, or any other such data which may affect the parameters of the data scrape. In order to complete a transaction with the provider, such information from the display website may be transferred to the provider website using a redirect routine.

For example, a system may scrape hotel inventory from hotel websites on a periodic basis. Such a periodic basis may be performed when a search is initiated, every second, minute, hour, day, week, month, or any other interval of time. When the pre-established scrape routine does not generate a data set, the record is flagged. The system then retrieves other scrape routines in its system and applies them to the website address. When a routine is found that is successful, the old routine is replaced by the new routine so that the website can be successfully scraped in the future. Once the new scraping routine has been established, the appropriate redirect routine is paired with the display record. The redirect routine allows links to be established from a hotel booking engine to the reservation engine of the hotel website. These links pass dates and numbers of guests to the reservation engine so that the data does not have to be re-entered. Similar systems may be used for any other inventory system, for example, for the purchase of particular goods and services including specialty or limited edition items. These systems may additionally be used for items generally tied to a specific physical location such as reservation systems for entertainment venues, sporting events, restaurants, rentals, classes, personal care, transportation and accommodations.

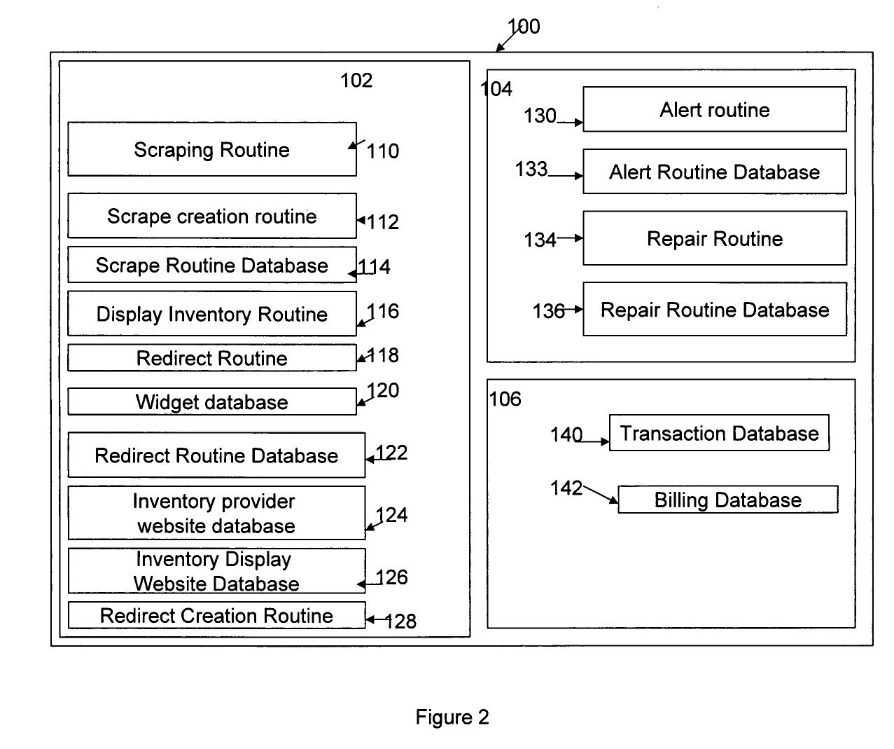

An exemplary system 100 configured to provide an alert and repair system as described above is shown in FIG. 2. As shown, system 100 may include an inventory management server 102, an alert server 104 and a financial server 106 or any other combination of servers, programs and databases. In some embodiments, the various programs and databases described below may be located on one or more servers.

Inventory management server 102 may include a variety of programs and databases including but not limited to, scraping routine 110, scrape creation routine 112, scrape routine database 114, display inventory routine 116, redirect routine 118, widget database 120, redirect routine database 122, inventory provider website database 124 inventory display website database 126, and redirect creation routine 128.

Alert server 104 may include a variety of programs and databases including, but not limited to, alert routine 130, alert routine database 132, repair routine 134 and repair routine database 136.

Financial server 106 may include a variety of programs and routines including, but not limited to, transaction database 140 and billing database 142.

Inventory provider website database 124 may include inventory provider identification, descriptor, web address associated with the inventory, inventory database type, scrape routine identification, redirect routine identification, associated alerts, repair routine or any additional information useful in identifying an inventory provider and maintaining an information transfer.

In some embodiments, the inventory collected by a scrape routine may be maintained with the inventory provider website database 124 In other embodiments, there may be a separate inventory provider website inventory database which may include information such as inventory provider identification, inventory ID, descriptor, date of scrape, date of inventory, price of inventory, restrictions on inventory, minimum/maximum requirements, associated alerts, repair routine, or any additional information that would be necessary to correctly display available inventory. In other embodiments, inventory may be constantly updated and it may not be necessary to maintain an inventory database.

Information regarding the website displaying the widget that includes the inventory may be stored, for example, in inventory display website database 126. Such a database may include information such as inventory display website identification, type, permissible inventory providers, widget type, associated alerts, and a repair routine, or any other additional information useful in identifying and maintaining widgets on a particular website.

Information about the widgets linking inventory and websites may be stored for example, in widget database 120. Widget database 120 may include information such as the widget type, widget descriptor, inventory provider, inventory display, associated alerts and repair routines.

A failure of a data scrape may be stored in alert routine database 132. Alert routine database 132 may include information such as an alert identification, alert descriptor, notification rules, response to the alert, number of times an alert has occurred, cause of the alert, date and time of the alert, repairs undertaken, type of alert, identification of the source of the alert, identification of the widget involved, identification of the scrape routine involved, identification of the location of the widget involved, identification of the inventory provider involved, or any other additional information useful in documenting that an alert has occurred.

A library of scrape routines may be maintained, for example in scrape routines database 114. Scrape routines database 114 may include information such as scrape routine identification, scrape routine descriptor, repair routines, scrape routines in use, available scrape routines, rules for generating scrape routines, or any other additional information useful in creating and using scrape routines.

A library of redirect routines may be maintained, for example, in redirect routines database 122. Redirect routines database 122 may include information such as the redirect routine identification, redirect routine descriptor, repair routine, rules for redirecting routines, redirect routines in use, available redirect routines, or any other additional information useful in creating and using redirect routines.

Transaction database 140 may keep track of every transaction involving a widget or other linkage from the display website. Such transactions may or may not involve a sale. Transaction database 140 may include information such as identification of the widget involved in the transaction, inventory provider identification, identification of the website where the inventory was displayed and/or the widget was located, end user identification, and the date and time of the transaction.

Billing database 142 may store information for the creation of invoices for the use of widgets or other display devices. Billing database 142 may include information such as inventory provider identification, advertisement identification, identification of the inventory display provider, fee calculation rules, price per click, revenue share, total clicks, division of fees, or any other information necessary to calculate fees involved in using a widget or other inventory display device.

In the event that an alert is issued and a repair is required, information on the repair routines may be gathered from repair routines database 136. Repair routines database 136 may include information such as repair routine identification, repair routine descriptor, repair routine condition, inventory display website where the alert occurred, inventory provider website that is the source of the alert. Such a database may also store information, or a separate or otherwise different database may store information on the scrape routine involved in a repair, the redirect routine involved in a repair, the repair date, and the type of the repair.

Inventory may be scraped by any means feasible. In one embodiment, inventory may be scraped using a scraping routine 110. Such a routine may use some or all of the following steps in order to generate inventory.
1. Retrieve a set of inventory provider websites to scrape.
2. Retrieve/generate a scrape routine for each inventory provider website.
3. Apply scrape routine to each inventory provider website.
4. Determine if scrape for each inventory provider was successful.
5. If a scrape was unsuccessful flag an inventory provider website as “failed to scrape.”

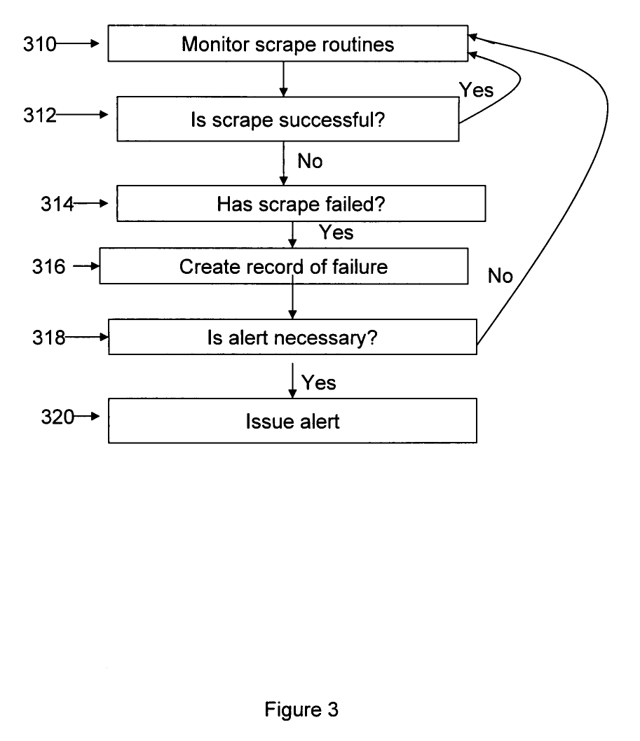

In the event that a scrape was unsuccessful, an alert may created. For example, some or all of the steps in FIG. 3 may be used in which scrape routines may be monitored at 310. If scrapes are successful at 312, the routine simply monitors the scrapes. If the scrape fails at 314, a record of the failure may be recorded at 316 and a determination if an alert is needed may be made at 318. In some instances, the scrape may be successful during a second try or a substitute routine may be located or generated in which case an alert may not be necessary. If an alert is not necessary, the system may return to monitoring scrape routines at 310. In the event that a determination is made that an alert is necessary, the alert may be issued at 320.

An alert may be created by any means possible and may be communicated by any means designed to attract the attention of a repair entity or administrator. In some embodiments, an alert may be sent internally and may be self repairing. In another embodiment, an alert may require human intervention in order to address the problem. Alerts may be sent, for example, using email, phone calls, instant messaging, text messaging, physical mail, voice mail, pager, graphic message, audio message, physical mail, fax, any other communications means or any combination thereof. In some embodiments, alerts may be sent using some or all of the following steps:
1. Receive notification of a failure to scrape.
2. Retrieve information regarding notification procedures for inventory provider.
3. Send notification.

There are a variety of actions that may be taken by the system in the event that a scrape fails. In some embodiments, the system may attempt to repair or replace the failed scrape. Such an attempt may be made regardless of whether an alert is issued and may be made prior to, after or during the issuance of an alert. In some embodiments, an attempt may be made by the system to replace the failed scrape using some or all of the following steps:
1. Receive notification of failed scrape.
2. Retrieve flagged inventory provider record.
3. Apply alternate scraping routines.
4. Determine if alternate scrape routine was successful.
5. Replace failed scrape routine with successful scrape routine.

Alternate scraping routines may be stored in a library or other database such as scrape routine database 114. In other embodiments, the system may generate new scraping routines using a rules or genetic algorithm. The generation of new scraping routines may use some or all of the following steps:
1. Retrieve/generate routine rules.
2. Create routine based on rules.
3. Apply routine to inventory provider website.
4. Determine if routine is successful.
5. Store successful routine in appropriate library and associate with inventory provider record.

In other embodiments, attempts may be made by the system to repair the failed scrape routine using Repair Routine 134. Repair Routine 134 may use some or all of the following steps:
1. Receive notification of failed scrape.
2. Retrieve flagged inventory provider record.
3. Determine appropriate repair routine.
4. Apply repair routine to inventory provider scrape routine.
5. Test repair routine success.
   In the event that the repair routine fails, alternate repair routines may be tested until a repair succeeds. In some embodiments, alerts may be sent indicating that a repair routine is attempting to correct a problem or that a scrape routine is being replaced, or both, as well as notification of the success or failure of the replacement.

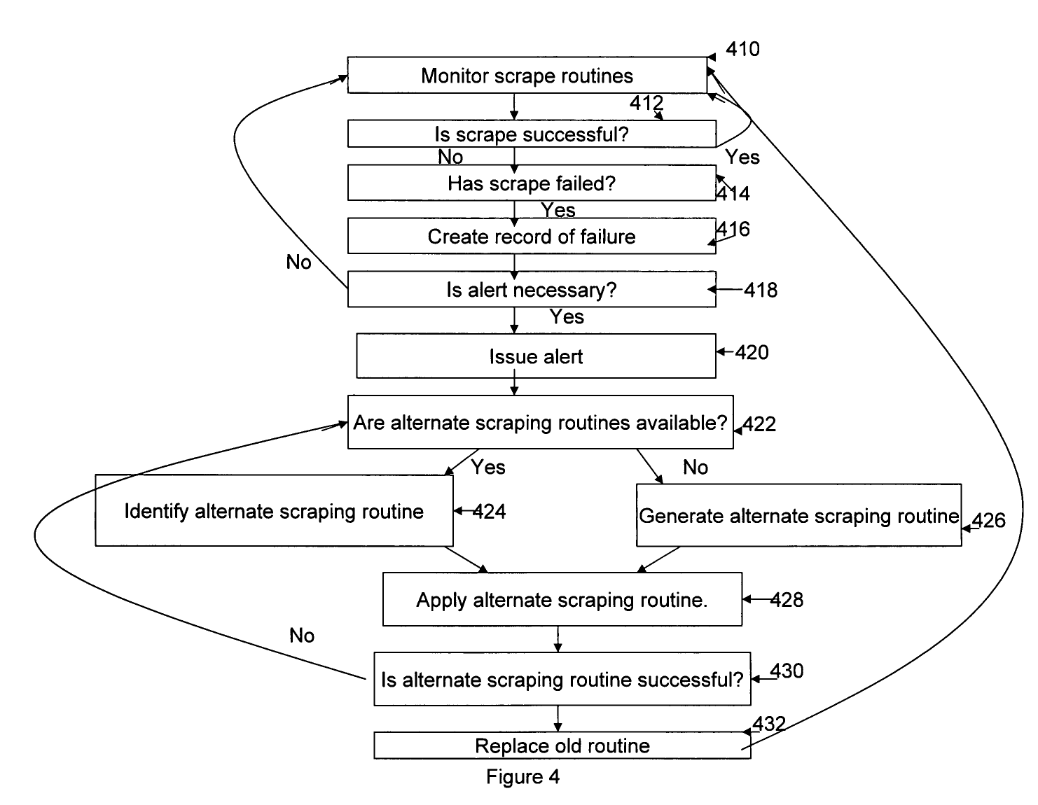

For example, as shown in FIG. 4, scrape routines may be monitored 410. If a scrape is successful 412, the system returns to monitoring the scrape routines. If the scrape fails 414, a record of the failure is made 416. A determination is made at 418 if an alert needs to be issued. If an alert does not need to be issued, for example if the scrape is successful on a second attempt or with different search parameters, the routine returns to monitoring scrapes. If it is necessary to issue an alert, an alert is issued at 420. The system may attempt to repair or replace the routine at 422. A determination may be made as to whether there are alternate scraping routines available in the scrape routine database. If there are alternate scraping routines, they may be attempted at 424. If there are no alternate scraping routines available or all of the alternate scraping routines have already been attempted, the system may attempt to generate a new alternate scraping routine at 426. The alternate scraping routines may then be applied to the system at 428 and a determination may be made at 430 as to whether the alternate scraping routine was successful. If the alternate scraping routine was successful, the old routine is replaced and the system returns to monitoring scrape routines. If the alternate scraping routine is unsuccessful, the system determines if there are alternate scraping routines available at 422 and attempts other scraping routines. In some embodiments a second or subsequent alert may be generated if the replacement scraping routine fails.

In some embodiments, it may not be possible for the system to repair or replace the scrape routine. In such embodiments, the system may redirect the end user to the inventory provider website so that they can enter into a transaction directly. In other embodiments, for example if the inventory provider website no longer exists or is malfunctioning, the end user may be returned to the home page of the inventory display website.

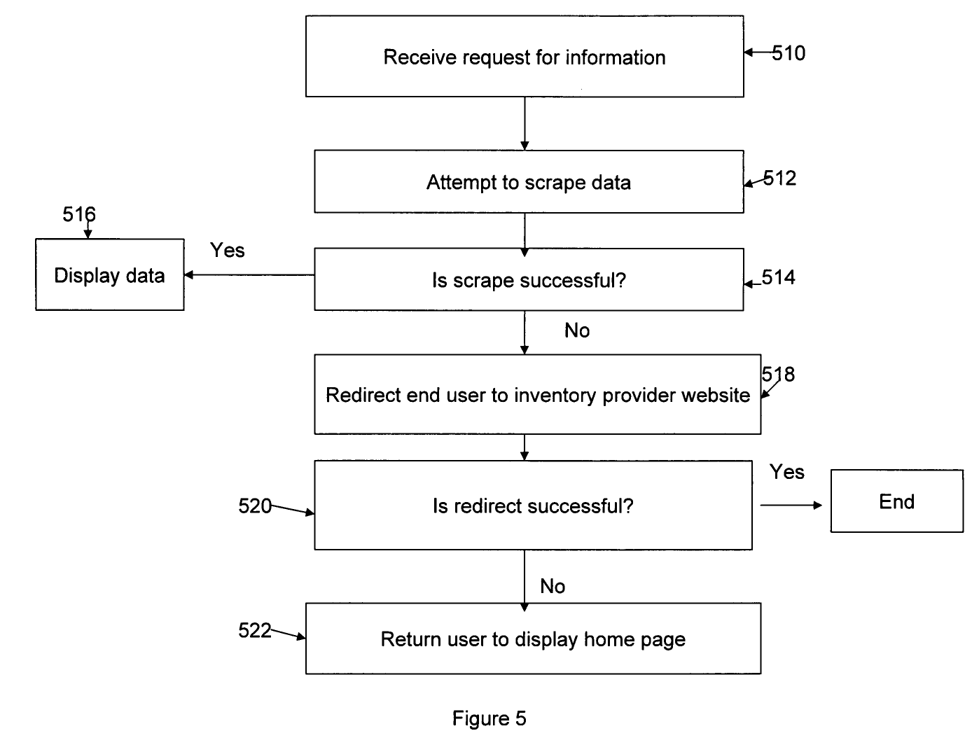

For example, some or all of the steps in FIG. 5 may be used in which a request for information is received 510. An attempt is made to scrape the data 512 and a determination is made as to whether the scrape was successful 514. If the scrape was successful, the information is displayed 516 in a widget or other format on the display web page. If the scrape is unsuccessful, the end user is redirected to the data provider website 518 such as the website for a hotel or restaurant or other inventory provider. If the redirect is successful, the routine ends. If the redirect is unsuccessful, i.e. the system is unable to make a connection with the data provider website, the end user may be returned to the home page for the display website.

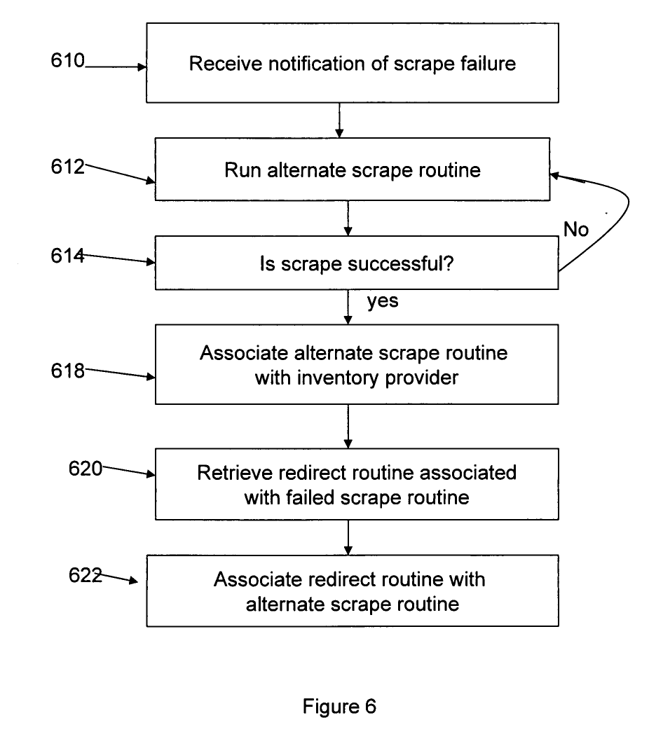

Display websites may display information and/or may connect an end user with the source of the information provided. In some embodiments, a scrape routine may be paired with a redirect routine that directs an end user from a display website to a source website such as an inventory provider website. Such a redirection may be via a hyperlink or any other connection method. In some embodiments, data that has been entered into the display website may be transferred to the source website. Such information may include data such as, but not limited to, the dates of a trip, inventory descriptors, part numbers, the number of people in a party, a cookie session, addresses, billing information, or any other relevant data. In some embodiments, a data scrape may be paired with a redirect routine. In the event that a scrape routine is replaced, the redirect routine needs to be paired with the new scrape routine. Such a pairing may occur using some or all of the steps of FIG. 6. For example, the system may receive notification that a scrape routine has failed 610. An alternate scrape routine is run 612. A determination is made 614 as to whether or not the new routine was successful in scraping the data. If the alternate scrape is unsuccessful, successive attempts may be made to run an alternate scrape routine. If the scrape is successful, the alternate scrape routine may be associated with the inventory provider 618 in the inventory provider database 124. The redirect routine associated with the failed scrape routine may be retrieved 620 and associated with the alternate scrape routine 622.

In some embodiments, a redirect routine may fail. In such embodiments, repair routine 134 may use some or all of the following steps to repair a redirect routine.
1. Retrieve inventor provider website record that is flagged as “failed to redirect.”
2. Retrieve alternate redirect routine.
3. Apply alternate redirect routine to inventory provider website.
4. Determine if alternate redirect routine was successful.

In additional embodiments, it may be useful to create redirect routines to replace damaged or failed scrape and redirect routines. In such embodiments, some or all of the following steps may be used:
1. Retrieve/generate routine rules.
2. Create routine based on rules.
3. Apply routine to inventory provider website.
4. Determine if routine is successful.
5. Store successful routine in appropriate library and associate with inventory provider record.

In other embodiments, attempts may be made by the system to repair the failed redirect routine using Repair Routine 134. Repair Routine 134 may use some or all of the following steps:
1. Receive notification of failed redirect.
2. Retrieve flagged inventory provider record.
3. Determine appropriate repair routine.
4. Apply repair routine to inventory provider redirect routine.
5. Test repair routine success.
   In the event that the repair routine fails, alternate repair routines may be tested until a repair succeeds. In some embodiments, alerts may be sent indicating that a repair routine is attempting to correct a problem or that a redirect routine is being replaced, or both, as well as notification of the success or failure of the replacement.

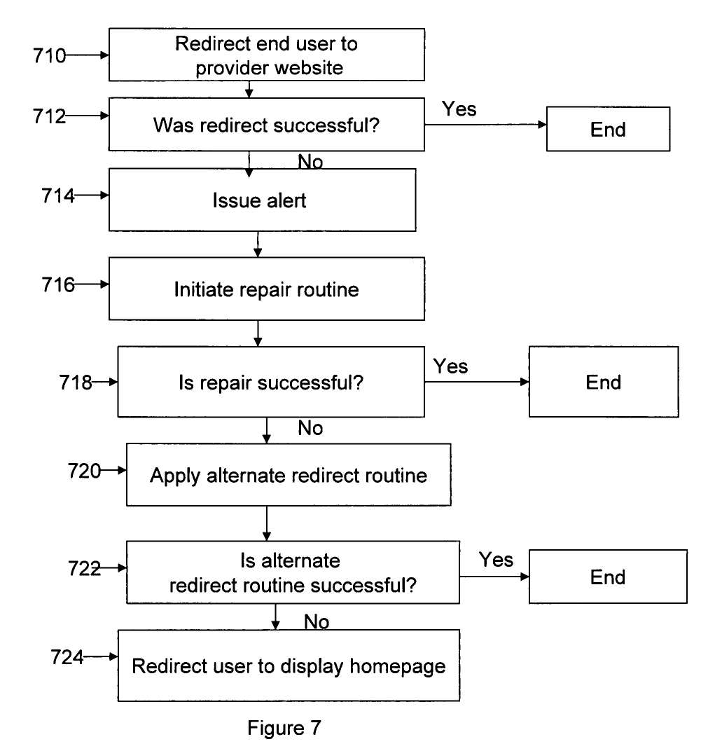

For example, some or all of the steps in FIG. 7 may be used in which an attempt 710 is made to redirect an end user to the website providing the data displayed in the data scrape. At 712, a determination is made as to whether the attempt was successful. If the attempt is successful, the routine ends. If the attempt is unsuccessful, an alert is issued at 714. An alert may be created by any means possible and may be communicated by any means designed to attract the attention of a repair entity or administrator. In some embodiments, an alert may be sent internally and may be self repairing. In another embodiment, an alert may require human intervention in order to address the problem. Alerts may be sent, for example, using email, phone calls, instant messaging, text messaging, physical mail, voice mail, pager, graphic message, audio message, physical mail, fax, any other communications means or any combination thereof. In some embodiments, alerts may be sent using some or all of the following steps:
1. Receive notification of a failure to redirect.
2. Retrieve information regarding notification procedures for inventory provider.
3. Send notification.
   The system may also initiate a repair routine 716. At 718, it may be determined if the repair was successful. If the repair is successful, the routine ends. If the routine is unsuccessful, the system may attempt an alternate redirect routine. An alternate redirect routine may be selected from existing redirect routines, for example from Redirect Routine Database 122 or may be generated for example using redirect creation routine 128. A determination may be made at 722 as to whether or not the redirect routine is successful. If it is successful the routine may end. If it is not successful, the user may be redirected to the display homepage at 724 or an alternate redirect routine may be applied.

### CONCLUSION

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

We claim:

1. A method of obtaining information comprising:
attempting to perform a data scrape of a web page;
determining if the data scrape has been successful; and
issuing an alert if the data scrape has been unsuccessful.

2. The method of claim 1, wherein the alert is email messages, phone communications, instant messaging, text messaging, physical mail, voice mail, pager, graphic, text or audio message, or record entry.

3. The method of claim 1, wherein the data scrape is performed by a data scrape routine.

4. The method of claim 3, wherein if the data scrape is unsuccessful, the data scrape routine is replaced.

5. The method of claim 4, wherein the replacement data scrape routine is selected from a pre-existing set of data scrape routines.

6. The method of claim 4, wherein the replacement data scrape routine is generated using a rules or genetic algorithm.

7. The method of claim 3, wherein if the data scrape is unsuccessful, the data scrape routine is repaired.

8. The method of claim 1, wherein the data scrape is associated with a redirect routine.

9. A method of connecting an end user to information comprising:
receiving the terms of a search;
displaying the results of the search on a web page;
receiving a selection of a search result on a web page;
attempting to redirect the end user to a source of the search result displayed on the web page;
determining if the redirection has been successful; and
issuing an alert if the redirection has been unsuccessful.

10. The method of claim 9, wherein the alert is email messages, phone communications, instant messaging, text messaging, physical mail, voice mail, pager, graphic, text or audio message, or record entry.

11. The method of claim 9, wherein the redirection is performed by a redirect routine.

12. The method of claim 11, wherein if the redirection is unsuccessful, the redirect routine is replaced.

13. The method of claim 12, wherein the replacement redirect routine is selected from a pre-existing set of redirect routines.

14. The method of claim 12, wherein the replacement redirect routine is generated using a rules or genetic algorithm.

15. The method of claim 11, wherein if the redirect is unsuccessful, the redirect routine is repaired.

16. A system comprising:
a search engine configured to receive a search query from a user and output a search result;
a user interface configured to allow a user to send a search query to the search engine;
a data scrape routine for obtaining information based on the search query;
a web page for displaying the information obtained from the data scrape;
a user interface that allows a user to select a particular search result;
a redirect routine for transferring the user to the source of the search result; and
a means for verifying the success or failure of the scrape routine and redirect routine.

17. The system of claim 16, further comprising a means for issuing an alert if the scrape routine or redirect routine fails.

18. The system of claim 17, wherein the alert is email messages, phone communications, instant messaging, text messaging, physical mail, voice mail, pager, graphic, text or audio message, or record entry.

19. The system of claim 16, wherein if the scrape routine is unsuccessful, the system alters the parameters of the search query.

20. The system of claim 16, wherein if the scrape routine or redirect routine is unsuccessful, the system replaces the unsuccessful routine.
